(19) United States
(12) Patent Application Publication
(10) Pub. No.: US 2012/0129137 A1
(43) Pub. Date: May 24, 2012

(54) Video and Pictorial Mathematical Learning Kit and Method

(76) Inventor: Canaa Lee, Dallas, TX (US)

(21) Appl. No.: 13/269,661

(22) Filed: Oct. 10, 2011

Related U.S. Application Data
(60) Provisional application No. 61/414,989, filed on Nov. 18, 2010.

(51) Int. Cl. G09B 23/02

(52) U.S. Cl. 434/188

(57) ABSTRACT

A kit and method is described for introducing mathematical concepts to children through video tutorials and pictorial flash cards. The video tutorials include visual and auditory stimulation based on instructional and entertaining skits, cinematic representations and similar means to deliver and reinforce concepts. The flash cards correspond to the content of the videos tutorials, and are useful before, during and after the video tutorials for further reinforcement of the provided concepts. The kit and method utilize association and repetition as a basis to teach young children, and to provide physical meaning of basic mathematical concepts without requiring abstract thought or computational thinking therefrom. The kit may be tailored to a given audience by varying the chosen videos and flash cards based on a predefined lesson plan, allowing an instructor or parent to adjust the difficulty level to an appropriate level for a particular child or classroom of children.

### CROSS REFERENCE TO RELATED APPLICATION

This application claims the benefit of U.S. Provisional Application No. 61/414,989 filed on Nov. 18, 2010, entitled “Your Baby Can Do Math.”

### BACKGROUND OF THE INVENTION

### Field of the Invention

The present invention relates to a method and kit involving video tutorials and associated pictorial flashcards to assist in the learning and retention of mathematical concepts through association and reptition.

Many students may dislike math because they cannot easily grasp fundamental math concepts. This leads to students performing poorly in math and math-related classes, subsequently causing declines in grades and self-esteem. The lack of ability to easily grasp math concepts may be due to late introduction of math into a child's education. Thus, children may benefit from techniques taught early on that will foster retention of information and conceptual understanding.

Experienced teachers know that young children, although bright, may have difficulty learning arithmetic. This age group is much more visually or interactively oriented, and therefore exhibit trouble comprehending numerical concepts through traditional book learning. Such abstract thinking at a young age is difficult for most. Such children have more success with teaching methods that employ pictures, audio, and other interactions to convey concepts. In order to reach these children, there is a need for a method of teaching arithmetic that conveys mathematical ideas through a combination of visual illustrations and videos, and relating those illustrations to accompanying instructions that are both educational and entertaining.

Graphical devices have often been employed to teach educational topics. In particular, flash cards and posters are often employed; however these methods are not always helpful because they lack more than a basic visual component. Thus a desirable method of communicating and teaching mathematical concepts would include a variety of audio, visual and interactive means. The present invention, using a series of video tutorials and related flash cards, provides such a means at a variety of education levels and to fulfill a long felt need in the art. The kit and method utilize physical association of concepts and repetition thereof as a means to introduce and reinforce basic mathematical concepts.

### DESCRIPTION OF THE PRIOR ART

Several patents have been issued and applications published that pertain to instructional lessons for children using video, flash cards, or both. The prior art also discloses approaches for educating children, such as repetition, words, and associated pictures. However, these prior art methods and kits have several known drawbacks that are remedied in the present invention.

There are several systems and methods for instructional learning that involve custom devices. U.S. Patent Publication No. 2007/0048716 to Hsu is directed to a learning system that includes a textbook and an integrated control for a video playback device to display educational video and audio content on a monitor. The system may include one or more sensors in communication with the control. Similarly, U.S. Pat. No. 5,556,283 to Stendardo is directed to an electronic learning system that utilizes a plurality of coded cards on which sensory information representations are provided. These cards present pictorial-symbol information and/or language-symbol information. The cards are used in conjunction with a housing that contains card slots with a visually and functionally distinctive buttons associated with each individual card slot and a button associated in an equal manner to all card slots, wherein a card may be inserted in each of the card slots. The operator causes the system to generate audible information associated with the representation on any selected card by pressing the distinctive button associated with the card slot in which the card is inserted. The operator can also cause the system to generate audible information associated with the representation provided on each inserted card and, depending on the type of cards installed, perform secondary functions as the individual cards are being accessed. These secondary functions can include mathematical computations, pattern recognition, and spelling exercises by pressing the button associated with all card slots.

The Hsu publication and Stendardo patent provide methods and systems of learning with the aid of specialized devices. The present invention requires only a single means of audio and visual playback. Thus, the present invention is suitable for group or one-on-one instruction, and does not require specialized equipment that may break or be lost. Further, such equipment may not be suitable for all ages and education levels, particularly the level of a very young child, whereas the present invention may be tailored to the needs of any student, even the very young.

Other inventions are directed towards using more adult technologies and are not suited for teaching or for applications involving children. U.S. Patent Publication No. 2008/0021852 to Williams is directed to a method and system for automated learning through repetition. The method and system may improve automated learning of information for religious, academic purposes or pleasure by presenting pre-determined patterns selected specifically based on a belief system for a learner for an optimal learning of information. While useful for teaching adults, very young children are unlikely to have access to or the knowledge to use the technologies required. The present invention makes use of any standard audio visual playback device, and is accessible to all ages of children and even adults of all levels of education and technological exposure.

Other patents provide learning systems that require one-on-one interaction. U.S. Pat. No. 6,579,100 to Clark is directed to a learning system method for infants, toddlers and young children that makes use of selected visuals stored on an audiovisual storage and playback device in conjunction with unique flash cards to provide an enhanced learning experience. The Clark invention requires constant and customized interaction with the learning child, which may not be feasible in all situations. The present invention is suitable for both individual and group learning situations.

Other inventions are useful for providing instruction only at the most basic levels, and do not allow for a more difficult or otherwise customizable lesson plans. U.S. Pat. No. 7,977,654 to Burtness is directed to a visual method of teaching arithmetic, in which graphical representations of familiar objects are used instead of numbers. The shapes of the objects resemble the numerals zero through nine. The objects may appear on any visual medium. Students are first shown examples of multiplication, division, addition, and subtraction, in which objects replace numbers. Each object is then shown by itself. The numeral that corresponds to the number value of each object is then overlaid on top of each object. Students are also shown groups of colored dots or balls, in which the colors of the dots match the colors of the objects and the number of dots corresponds to the numerical value represented by its corresponding object. The Burtness invention uses creatively designed animals to depict numerical values. While useful and entertaining for introductory concepts, larger mathematical problems will quickly become confusing and frustrating. For example, a five digit number when depicted as animals within an equation of other numbers depicted as animals will quickly become more confusing than useful.

Still other inventions provide entertaining learning systems for teaching use, but require significant legwork and development on the part of the teacher. U.S. Pat. No. 7,223,102 to Powell is directed to a system and method for teaching basic mathematical operations and facts. More particularly, it is an apparatus for the development of accurate conceptual models for small children in learning certain math facts for the first time. In the Powell invention, every digit of any number gets a familiar yet consistent name; that name can be weaved into story and rhyme throughout the learning process in both the math questions and in the math answers. The consistent “name for a digit” advancement creates a conceptual model to which children can relate. Digit consistency throughout the system, series, or television program helps teachers create relevant meaningful applications and activities. The Powell invention requires the development of lesson plans and other devices for usage. Further, the Powell invention will become more difficult to develop and use as the mathematical concepts become more complex. The present invention requires little preparation for usage other than the choice of difficulty level.

In view of the foregoing prior art patents, there is a clear need in the art for a system and method to facilitate teaching of mathematical concepts to children of all ages, and in particular children of a very young age, while still being adaptable for individuals of all education level. Such invention should be useful without excess or limiting devices, with deployable with limited preparation and usable for all levels of instruction. The present invention fulfills this need in the art by providing a method and kit to teach mathematics to young children through a program using interactive video, which is customizable to a variety of difficulty levels.

### SUMMARY OF THE INVENTION

In view of the foregoing disadvantages inherent in the known types of instructional kits and methods now present in the prior art, the present invention provides a new mathematical instruction kit and method wherein the same can be utilized for providing convenience for the user when teaching children fundamental mathematical concepts.

The present invention is designed to facilitate learning of math concepts by young children. This innovative kit and method features a set of pictorial flash cards and complementary instructional videos. The flash cards display numbers, corresponding pictures, and combinations of physical quantities and mathematical notations to establish an association of math concepts with their physical meaning. The concept behind the invention is the reinforcement of knowledge through association, repetition, and audio and visual stimulation for optimal introduction and retention of basic mathematical concepts. Use of the present invention is designed to increase the ability of a child to process and apply knowledge at an early age without requiring critical thinking or computational ability.

It is therefore an object of the present invention to provide a kit and method comprising video tutorials and pictorial flash cards. It is a further object of the present invention to teach fundamental math concepts though words, pictures, and pattern association and repetition.

Another object of the present invention is to provide initial instruction in mathematical concepts using video tutorials, followed by or in conjunction with a series of flash cards that provide introduction of mathematical concepts through association and repetition using words, pictures and patterns.

Yet another object of the present invention is to provide a kit and method that is easily deployable with minimal preparation time and with no specifically designed tools or apparatuses.

Other objects, features and advantages of the present invention will become apparent from the following detailed description taken in conjunction with the accompanying drawings.

### DETAILED DESCRIPTION OF THE INVENTION

The present invention is ideally suited for helping young children understand and apply fundamental math concepts at an early age through the use of visual and auditory association. The invention comprises a set of instructional video tutorials and related pictorial flash cards that provide repetitive visual and audio lessons that allow children to relate mathematical concepts to physical quantities and entities without requiring complex thought or critical thinking.

The kit and method helps children construct a basic understanding and foundation for mathematics and numbers. The goal is to relate simple concepts, such as number counting and basic arithmetic, to physical objects and quantities using association as a method of introduction. Basic math concepts of interest include counting patterns, adding, reading and speaking numbers, understanding place values, adding and subtracting, multiplication and division, reading aloud fractions, understanding the concept fractions, decimals, and other basic arithmetic concepts. The goal is to reduce abstract thoughts to concrete, real-world and child relatable material that allows a young child to understand the meaning and usefulness of mathematics while young. The goal is further to introduce these concepts through a medium that provides entertainment and visual and audio stimulation to entertain and educate at the same time.

The kit comprises a set of video tutorials and place cards that can be used together or separately therefrom. The videos provide both a visual and auditory medium for communication, while the cards provide similar information contained within the videos but in a still frame format. The cards are colorful and visually stimulating, but lack the auditory input provided by the videos. The cards may be used separately from the videos if a television is not provided; however they are ideally suited for use in conjunction with the video through pattern exercises and interaction with the child. If in a classroom setting, the video may be used while in class, and the cards may be used while the child is at home. The cards comprise a plurality of still visuals that are provided via the video, and therefore may be used simultaneously or independently therefrom.

The concepts conveyed through the videos and cards are provided in a format to show obvious relationships and allow easy understanding without requiring computation or abstract thought. For example, an exercise discussing the concept of a fraction may illustrate what a fraction is by showing a fraction in written form, and then illustrating it with a clever or useful illustration. On the screen may be shown “½” along with an illustration of a half eaten pie, as well as “0.50” and “50%”). Simpler lessons may include number counting, and having the number digit placed next to a row of countable objects, such as farm animals or objects that may interest a young child. As the child sees the number images on their television screens, hear the numbers as they are spoken on the videos, and see the numbers written on the cards, physical meaning and association of these concepts are conveyed without requiring abstract thoughts. Association of digits with a countable quantity of objects provides the child with a meaning to the digit, while repetition of these concepts improves retention of the information. The overall approach is to provide an understanding of how mathematical concepts relate to one another and how they carry physical meaning.

Young children require a framework from which to build critical, abstract or computational thinking processes that will develop later in life. Education by association and repetition allows a child to build such a framework and absorb information without realizing they are being taught. It is therefore of extreme importance that the videos and flash cards employ highly entertaining and engaging features that are attractive to children. This allows the child to be entertained and taught at the same time. Concepts on the videos and cards may be selected by a parent or teacher to allow customization of the program content to a level appropriate for a particular child or classroom of children.

The pictorial flash cards display images of numbers, instructional pictures, words, and still images from the tutorials and include various types of mathematical concepts. The cards and videos can show colorful, stimulating images, have written instructional statements, equations or other pictorial devices to assist in learning. Further, the cards may include references to the included skits or other cinematic features to encourage the attentiveness of the watching children. In particular, these references may include still images from the tutorial videos. The cards may be used before viewing the videos to introduce concepts, during viewing for reinforcement or after viewing the videos to review. The cards are designed in a attractive and colorful to stimulate interest, while the videos are interactive, entertaining and include a plurality of sensory stimulating features. Videos and cards may be designed around a specific theme to further increase interest, such as animals, television characters, popular movies or any central topic of potential interest to children. Kits may come in a variety of difficulties, allowing the parent or teaching to select the most appropriate level for the child.

Overall, the primary point of novelty provided by the present invention is the introduction of a kit that provides both a series of videos and associated flash cards for use by children prior to formal education or at the onset thereof. Early introduction of educational topics can have a profound impact on the educational trajectory of a child, as these early stages provide a framework, foundation and set of building blocks from which to base more complex thoughts and ideas from as the child's brain develops. The kit itself is the combination of videos and flashcards, while the content is presented in manner that provides association of concepts and repetition thereof, through a medium that is both entertaining and engaging for young children.

With respect to the above description then, it is to be realized that the optimum dimensional relationships for the parts and steps of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A kit for the instruction of mathematical concepts to young children through association and repetition, comprising:
a series of instructional video tutorials, said videos providing an auditory and visual medium through which basic math concepts are shown, associated to physical quantities and repeated for memory retention in young children;
a set of flash cards corresponding and relating to said video tutorials, said flash cards providing interaction with said videos and providing a visual medium through which basic mathematical concepts are shown and associated to physical quantities;
said videos and order of said flash cards being controllable to provide a set difficulty level and a specific mathematical topic of interest.

2) A kit as described in claim 1, wherein said mathematical topics include counting, number digit introduction and association, arithmetic concepts such as adding, subtracting, multiplying and dividing, fractions, and decimals.

3) A kit as described in claim 1, wherein said flash cards are used in conjunction with said video tutorials for interactive teaching.

4) A kit as described in claim 1, wherein said flash cards are used separately from said video tutorials.

5) A method of instructing mathematical concepts to a child using association and repetition of basic concepts, comprising the steps of:
displaying a series of one or more video tutorials that comprise auditory and visual association of mathematical concepts with physical quantities and measures and provide repetition of said concepts for retention;
deploying visual flash cards associated to said video tutorials, wherein said flashcards comprise visual association of mathematical concepts with physical quantities and measures and provide repetition of said concepts for retention;

6) A method as described in claim 5, further comprising the steps of
adjusting the level of difficulty of said mathematical concepts in said video tutorials and said flashcards to account for child ability and maturity level.

7) A method as described in claim 5, further comprising the steps of:
using said visual flash cards in conjunction with said video tutorials for interactive learning purposes.

8) A method as described in claim 5, further comprising the steps of:
using said visual flash cards separately from said video tutorials for independent and visual input learning.
